(19) United States
(12) Patent Application Publication
(10) Pub. No.: US 2024/0136827 A1
(43) Pub. Date: Apr. 25, 2024

(54) Method of Battery Balancing an Electrical Series String of Lithium-Ion Batteries, and System Thereof

(71) Applicant: The Noco Company, Glenwillow, OH (US)

(72) Inventors: James P. McBride, Phoenix, AZ (US); James Richard Stanfield, Glendale, AZ (US)

(21) Appl. No.: 18/546,290

(22) PCT Filed: Feb. 23, 2022
(86) PCT No.: PCT/US2022/017522

§ 371 Date: Aug. 13, 2023

Related U.S. Application Data
(60) Provisional application No. 63/152,661, filed on Feb. 23, 2021.

(51) Int. Cl. H02J 7/00; H01M 10/44

(52) U.S. Cl. CPC H02J 7/0016; H01M 10/441; H01M 10/0525

(57) ABSTRACT

A battery balancing method and system for charging multiple batteries connected together in an electrical series string with a single electrical charger. For example, the battery balancing method and system utilizes the battery management system (BMS) of the individual batteries for providing battery balancing of the multiple batteries connected together in the electrical series string when charging the series string with the single electrical charger.

### FIELD

The invention relates to a method of battery balancing a State of Charge (SoC) of a string of lithium-ion batteries connected in an electrical series arrangement, and system thereof.

### BACKGROUND

Lithium-ion batteries are often designed using multiple lithium-ion cells arranged in electrical series in order to reach higher voltages required for applications.

No two lithium-ion battery cells are identical, even though battery manufacturers utilize a sophisticated procedure to sort and match cells during battery assembly. There is always small differences between lithium-ion batteries in SoC, capacity, internal resistance, self-discharge rate, and temperature characteristics. If these small differences in the lithium-ion cells are not addressed, the result will be divergence in cell voltage over time. Divergence in cell voltage can lead to poor battery performance and potential safety issues. For this reason, many batteries incorporate cell balancing into their Battery Management System (BMS).

There are two methods commonly used for cell balancing with lithium-ion batteries connected in electrical series, including passive balancing and active cell balancing.

Passive cell balancing is the most common. It is low-cost, easy to implement, and effective. In passive cell balancing, a load is switched across a cell during charging to bypass charge current in order to equalize it with the other battery cells. Each of the battery cells in the electrical series has its own bypass resistor.

Active cell balancing uses a more complex method that redistributes charge between the cells in order to maintain balance. Active cell balancing typically uses capacitors or inductors to store energy and redistribute energy between battery cells. This is a low-loss process that eliminates the power losses inherent in the resistive loading of passive cell balancing.

Cell balancing can be highly effective in maintaining balance between cells in a single battery pack. However, there also exists the need to balance batteries (e.g. rechargeable batteries, Li-ion rechargeable batteries) when connected together in an electrical series string.

Many applications require two or more batteries to be connected in electrical series to reach higher application voltages. This string of electrical series connected batteries is often charged and discharged as a single unit. This can give rise to imbalance between batteries, in the same way that imbalance arises between individual cells inside the batteries.

Inside a battery, the individual cells are matched during manufacturing, then the battery is sealed. In contrast, batteries in an electrical series string are not necessarily matched, and since they are separate and removable, they may be subjected to different conditions that can affect their SoC. For these reasons it is desirable to implement some method to balance electrical series connected batteries. Some common battery balance methods are described below.

### (1) No Balancing:

The most common situation is to not implement any form of battery balancing. Without balancing, the batteries may get far enough out of balance over time to cause the BMS to cause over-charge or over-discharge protection on one of the batteries to trigger. This opens the electrical series string of batteries resulting in application failure.

### (2) Charge Individual Batteries:

A simple solution to balancing series connected batteries is to charge each battery in an electrical series connected string separately. For example, a 48V system consisting of four (4) series connected 12V batteries would utilize four (4) individual 12V chargers (i.e. one 12V charger for each battery). This is an effective balancing strategy, but is cost and space prohibitive in many applications. Most system designers prefer a single charger for the entire electrical series connected battery string.

### (3) Periodic Check and Rebalance:

Another strategy used to balance electrical series connected batteries is to periodically check the balance and manually rebalance the batteries, if needed. In this method, the batteries are disconnected from the load and/or charger and are measured. If the batteries are out of balance, each one is charged individually with a charger to recover balance. While effective, this method has drawbacks such as the requirement to interrupt battery use to check balance, determining the optimal time interval for checking balance, and the fact that it's a manual operation that must be scheduled and performed.

### (4) External Balancing:

Battery charge balancing systems are available that are designed to monitor each battery in an electrical series connected string, and use balancing techniques to maintain balance between the batteries. These systems are external to the battery. They are effective, but require additional hardware outside of the batteries, and external wiring to each battery in the series string.

### SUMMARY

The present invention is directed to battery balancing multiple batteries connected together in an electrical series string when charging the multiple batteries with a single charger. The invention implements battery balancing between the multiple batteries electrically connected together is the electrical series string without any additional hardware or cabling outside the batteries. No communication is required between batteries. The battery balancing occurs inside each individual battery of the electrical series string.

The present invention involves implementing passive balancing at the individual battery level (e.g. pack level). Each individual battery has a balancing resistor which bypasses a portion of the charge current near the end of charging. In an electrical series connected string of batteries, this has the effect of reducing charge current on batteries with a higher voltage, while batteries with a lower voltage receive the full charge current. The results in the batteries with lower voltages to catch up to the batteries with a higher voltages. Depending on the amount of imbalance, the batteries may take one or more charge cycles to reach a balanced condition.

The presently described subject matter is directed to a method of battery balancing an electrical series string of lithium-ion batteries, the method comprising: providing multiple lithium-ion batteries connected together in the electrical series string of the lithium-ion batteries, the multiple lithium-ion batteries each having a battery management system (BMS) comprising a comparator, a MOSFET, and a balancing resistor, using the comparator to detect when the battery voltage of each of lithium-ion batteries is near end-of-charge, and then turning on each respective MOSFET of each of the lithium-ion batteries, wherein this sequence shunts a portion of the charge current flowing through the balance resistor, and bypassing the battery cells of each of the multiple lithium-ion batteries, which has the effect of slowing down charging of each of the lithium-ion batteries, and wherein a single electrical charger is used to charge the multiple lithium-ion batteries connected together in the electrical series string of the lithium-ion batteries.

The presently described subject matter is directed to a method of battery balancing an electrical series string of lithium-ion batteries, the method comprising: providing multiple lithium-ion batteries connected together in the electrical series string of the lithium-ion batteries, the multiple lithium-ion batteries each having a battery management system (BMS) comprising a comparator, a MOSFET, and a balancing resistor, using the comparator to detect when the battery voltage of each of lithium-ion batteries is near end-of-charge, and then turning on each respective MOSFET of each of the lithium-ion batteries, wherein this sequence shunts a portion of the charge current flowing through the balance resistor, and bypassing the battery cells of each of the multiple lithium-ion batteries, which has the effect of slowing down charging of each of the lithium-ion batteries, and wherein a battery voltage threshold where the balance resistor begins to bypass charge current it set to a voltage that is near the full charge voltage for the particular lithium-ion battery chemistry used.

The presently described subject matter is directed to a method of battery balancing an electrical series string of lithium-ion batteries, the method comprising: providing multiple lithium-ion batteries connected together in the electrical series string of the lithium-ion batteries, the multiple lithium-ion batteries each having a battery management system (BMS) comprising a comparator, a MOSFET, and a balancing resistor, using the comparator to detect when the battery voltage of each of lithium-ion batteries is near end-of-charge, and then turning on each respective MOSFET of each of the lithium-ion batteries, wherein this sequence shunts a portion of the charge current flowing through the balance resistor, and bypassing the battery cells of each of the multiple lithium-ion batteries, which has the effect of slowing down charging of each of the lithium-ion batteries, wherein a battery voltage threshold where the balance resistor begins to bypass charge current it set to a voltage that is near the full charge voltage for the particular lithium-ion battery chemistry used, and wherein as the electrical series string of batteries is charged, cell balancing will be turned on in each battery as it reaches the balance threshold, and eventually all of the batteries in the electrical series string will have cell balancing turned on.

The presently described subject matter is directed to a method of battery balancing an electrical series string of lithium-ion batteries, the method comprising: providing multiple lithium-ion batteries connected together in the electrical series string of the lithium-ion batteries, the multiple lithium-ion batteries each having a battery management system (BMS) comprising a comparator, a MOSFET, and a balancing resistor, using the comparator to detect when the battery voltage of each of lithium-ion batteries is near end-of-charge, and then turning on each respective MOSFET of each of the lithium-ion batteries, wherein this sequence shunts a portion of the charge current flowing through the balance resistor, and bypassing the battery cells of each of the multiple lithium-ion batteries, which has the effect of slowing down charging of each of the lithium-ion batteries, and wherein balancing is performed only during charging.

The presently described subject matter is directed to a method of battery balancing an electrical series string of lithium-ion batteries, the method comprising: providing multiple lithium-ion batteries connected together in the electrical series string of the lithium-ion batteries, the multiple lithium-ion batteries each having a battery management system (BMS) comprising a comparator, a MOSFET, and a balancing resistor, using the comparator to detect when the battery voltage of each of lithium-ion batteries is near end-of-charge, and then turning on each respective MOSFET of each of the lithium-ion batteries, wherein this sequence shunts a portion of the charge current flowing through the balance resistor, and bypassing the battery cells of each of the multiple lithium-ion batteries, which has the effect of slowing down charging of each of the lithium-ion batteries, wherein balancing is performed only during charging, and wherein the balancing requires the balancing circuit to detect when the battery is being charged.

The presently described subject matter is directed to a method of battery balancing an electrical series string of lithium-ion batteries, the method comprising: providing multiple lithium-ion batteries connected together in the electrical series string of the lithium-ion batteries, the multiple lithium-ion batteries each having a battery management system (BMS) comprising a comparator, a MOSFET, and a balancing resistor, using the comparator to detect when the battery voltage of each of lithium-ion batteries is near end-of-charge, and then turning on each respective MOSFET of each of the lithium-ion batteries, wherein this sequence shunts a portion of the charge current flowing through the balance resistor, and bypassing the battery cells of each of the multiple lithium-ion batteries, which has the effect of slowing down charging of each of the lithium-ion batteries, wherein balancing is performed only during charging, wherein the balancing requires the balancing circuit to detect when the battery is being charged, and wherein the balancing is done by setting the voltage threshold for balancing to be near the full charge voltage, and when the battery is charging and reaches this threshold, balancing is enabled.

The presently described subject matter is directed to a method of battery balancing an electrical series string of lithium-ion batteries, the method comprising: providing multiple lithium-ion batteries connected together in the electrical series string of the lithium-ion batteries, the multiple lithium-ion batteries each having a battery management system (BMS) comprising a comparator, a MOSFET, and a balancing resistor, using the comparator to detect when the battery voltage of each of lithium-ion batteries is near end-of-charge, and then turning on each respective MOSFET of each of the lithium-ion batteries, wherein this sequence shunts a portion of the charge current flowing through the balance resistor, and bypassing the battery cells of each of the multiple lithium-ion batteries, which has the effect of slowing down charging of each of the lithium-ion batteries, wherein balancing is performed only during charging, wherein the balancing requires the balancing circuit to detect when the battery is being charged, wherein the balancing is done by setting the voltage threshold for balancing to be near the full charge voltage, and when the battery is charging and reaches this threshold, balancing is enabled, and wherein after charge termination, the battery voltage will naturally relax to a voltage below the threshold which disables balancing.

The presently described subject matter is directed to a method of battery balancing an electrical series string of lithium-ion batteries, the method comprising: providing multiple lithium-ion batteries connected together in the electrical series string of the lithium-ion batteries, the multiple lithium-ion batteries each having a battery management system (BMS) comprising a comparator, a MOSFET, and a balancing resistor, using the comparator to detect when the battery voltage of each of lithium-ion batteries is near end-of-charge, and then turning on each respective MOSFET of each of the lithium-ion batteries, wherein this sequence shunts a portion of the charge current flowing through the balance resistor, and bypassing the battery cells of each of the multiple lithium-ion batteries, which has the effect of slowing down charging of each of the lithium-ion batteries, and wherein control electronics in the battery management system (BMS) can provide a signal to the balancing circuit that indicates if the battery is being charged.

The presently described subject matter is directed to a method of battery balancing an electrical series string of lithium-ion batteries, the method comprising: providing multiple lithium-ion batteries connected together in the electrical series string of the lithium-ion batteries, the multiple lithium-ion batteries each having a battery management system (BMS) comprising a comparator, a MOSFET, and a balancing resistor, using the comparator to detect when the battery voltage of each of lithium-ion batteries is near end-of-charge, and then turning on each respective MOSFET of each of the lithium-ion batteries, wherein this sequence shunts a portion of the charge current flowing through the balance resistor, and bypassing the battery cells of each of the multiple lithium-ion batteries, which has the effect of slowing down charging of each of the lithium-ion batteries, and wherein balancing current should be high enough to effectively balance batteries, but low enough to not interfere with the charge termination scheme used in battery chargers.

The presently described subject matter is directed to method of battery balancing an electrical series string of lithium-ion batteries, the method comprising: providing multiple lithium-ion batteries connected together in the electrical series string of the lithium-ion batteries, the multiple lithium-ion batteries each having a battery management system (BMS) comprising a comparator, a MOSFET, and a balancing resistor, using the comparator to detect when the battery voltage of each of lithium-ion batteries is near end-of-charge, and then turning on each respective MOSFET of each of the lithium-ion batteries, wherein this sequence shunts a portion of the charge current flowing through the balance resistor, and bypassing the battery cells of each of the multiple lithium-ion batteries, which has the effect of slowing down charging of each of the lithium-ion batteries, and wherein a value for balancing current to provide adequate balancing and work with most battery chargers is between 100 mA and 500 mA.

The presently described subject matter is directed to a method of battery balancing an electrical series string of lithium-ion batteries, the method comprising: providing multiple lithium-ion batteries connected together in electrical series, the multiple lithium-ion batteries each having a battery management system (BMS) comprising an Analog-to-Digital Converter (ADC), a microcontroller, a MOSFET, and a balancing resistor, using a microcontroller to read the battery voltage using the Analog-to-Digital Converter (ADC) to detect when the battery voltage is near end-of-charge, and then turning on the MOSFET, wherein this sequence shunts a portion of the charge current through the balance resistor, and bypassing the cells of each of the multiple lithium-ion batteries, which has the effect of slowing down charging of each of the lithium-ion batteries, and wherein a single electrical charger is used to charge the multiple lithium-ion batteries connected together in the electrical series string of the lithium-ion batteries.

The presently described subject matter is directed to a method of battery balancing an electrical series string of lithium-ion batteries, the method comprising: providing multiple lithium-ion batteries connected together in electrical series, the multiple lithium-ion batteries each having a battery management system (BMS) comprising an Analog-to-Digital Converter (ADC), a microcontroller, a MOSFET, and a balancing resistor, using a microcontroller to read the battery voltage using the Analog-to-Digital Converter (ADC) to detect when the battery voltage is near end-of-charge, and then turning on the MOSFET, wherein this sequence shunts a portion of the charge current through the balance resistor, and bypassing the cells of each of the multiple lithium-ion batteries, which has the effect of slowing down charging of each of the lithium-ion batteries, and wherein a battery voltage threshold where the balance resistor begins to bypass charge current it set to a voltage that is near the full charge voltage for the particular lithium-ion battery chemistry used.

The presently described subject matter is directed to a method of battery balancing an electrical series string of lithium-ion batteries, the method comprising: providing multiple lithium-ion batteries connected together in electrical series, the multiple lithium-ion batteries each having a battery management system (BMS) comprising an Analog-to-Digital Converter (ADC), a microcontroller, a MOSFET, and a balancing resistor, using a microcontroller to read the battery voltage using the Analog-to-Digital Converter (ADC) to detect when the battery voltage is near end-of-charge, and then turning on the MOSFET, wherein this sequence shunts a portion of the charge current through the balance resistor, and bypassing the cells of each of the multiple lithium-ion batteries, which has the effect of slowing down charging of each of the lithium-ion batteries, wherein a battery voltage threshold where the balance resistor begins to bypass charge current it set to a voltage that is near the full charge voltage for the particular lithium-ion battery chemistry used, and wherein as the electrical series string of batteries is charged, cell balancing will be turned on in each battery as it reaches the balance threshold, and eventually all of the batteries in the electrical series string will have cell balancing turned on.

The presently described subject matter is directed to a method of battery balancing an electrical series string of lithium-ion batteries, the method comprising: providing multiple lithium-ion batteries connected together in electrical series, the multiple lithium-ion batteries each having a battery management system (BMS) comprising an Analog-to-Digital Converter (ADC), a microcontroller, a MOSFET, and a balancing resistor, using a microcontroller to read the battery voltage using the Analog-to-Digital Converter (ADC) to detect when the battery voltage is near end-of-charge, and then turning on the MOSFET, wherein this sequence shunts a portion of the charge current through the balance resistor, and bypassing the cells of each of the multiple lithium-ion batteries, which has the effect of slowing down charging of each of the lithium-ion batteries, and wherein balancing is performed only during charging.

The presently described subject matter is directed to a method of battery balancing an electrical series string of lithium-ion batteries, the method comprising: providing multiple lithium-ion batteries connected together in electrical series, the multiple lithium-ion batteries each having a battery management system (BMS) comprising an Analog-to-Digital Converter (ADC), a microcontroller, a MOSFET, and a balancing resistor, using a microcontroller to read the battery voltage using the Analog-to-Digital Converter (ADC) to detect when the battery voltage is near end-of-charge, and then turning on the MOSFET, wherein this sequence shunts a portion of the charge current through the balance resistor, and bypassing the cells of each of the multiple lithium-ion batteries, which has the effect of slowing down charging of each of the lithium-ion batteries, and wherein balancing is performed only during charging, wherein the balancing requires the balancing circuit to detect when the battery is being charged.

The presently described subject matter is directed to a method of battery balancing an electrical series string of lithium-ion batteries, the method comprising: providing multiple lithium-ion batteries connected together in electrical series, the multiple lithium-ion batteries each having a battery management system (BMS) comprising an Analog-to-Digital Converter (ADC), a microcontroller, a MOSFET, and a balancing resistor, using a microcontroller to read the battery voltage using the Analog-to-Digital Converter (ADC) to detect when the battery voltage is near end-of-charge, and then turning on the MOSFET, wherein this sequence shunts a portion of the charge current through the balance resistor, and bypassing the cells of each of the multiple lithium-ion batteries, which has the effect of slowing down charging of each of the lithium-ion batteries, wherein balancing is performed only during charging, and wherein the balancing requires the balancing circuit to detect when the battery is being charged, wherein the balancing is done by setting the voltage threshold for balancing to be near the full charge voltage, and when the battery is charging and reaches this threshold, balancing is enabled.

The presently described subject matter is directed to a method of battery balancing an electrical series string of lithium-ion batteries, the method comprising: providing multiple lithium-ion batteries connected together in electrical series, the multiple lithium-ion batteries each having a battery management system (BMS) comprising an Analog-to-Digital Converter (ADC), a microcontroller, a MOSFET, and a balancing resistor, using a microcontroller to read the battery voltage using the Analog-to-Digital Converter (ADC) to detect when the battery voltage is near end-of-charge, and then turning on the MOSFET, wherein this sequence shunts a portion of the charge current through the balance resistor, and bypassing the cells of each of the multiple lithium-ion batteries, which has the effect of slowing down charging of each of the lithium-ion batteries, wherein balancing is performed only during charging, and wherein the balancing requires the balancing circuit to detect when the battery is being charged, wherein the balancing is done by setting the voltage threshold for balancing to be near the full charge voltage, and when the battery is charging and reaches this threshold, balancing is enabled, and wherein after charge termination, the battery voltage will naturally relax to a voltage below the threshold which disables balancing.

The presently described subject matter is directed to a method of battery balancing an electrical series string of lithium-ion batteries, the method comprising: providing multiple lithium-ion batteries connected together in electrical series, the multiple lithium-ion batteries each having a battery management system (BMS) comprising an Analog-to-Digital Converter (ADC), a microcontroller, a MOSFET, and a balancing resistor, using a microcontroller to read the battery voltage using the Analog-to-Digital Converter (ADC) to detect when the battery voltage is near end-of-charge, and then turning on the MOSFET, wherein this sequence shunts a portion of the charge current through the balance resistor, and bypassing the cells of each of the multiple lithium-ion batteries, which has the effect of slowing down charging of each of the lithium-ion batteries, and wherein control electronics in the battery management system (BMS) can provide a signal to the balancing circuit that indicates if the battery is being charged.

The presently described subject matter is directed to a method of battery balancing an electrical series string of lithium-ion batteries, the method comprising: providing multiple lithium-ion batteries connected together in electrical series, the multiple lithium-ion batteries each having a battery management system (BMS) comprising an Analog-to-Digital Converter (ADC), a microcontroller, a MOSFET, and a balancing resistor, using a microcontroller to read the battery voltage using the Analog-to-Digital Converter (ADC) to detect when the battery voltage is near end-of-charge, and then turning on the MOSFET, wherein this sequence shunts a portion of the charge current through the balance resistor, and bypassing the cells of each of the multiple lithium-ion batteries, which has the effect of slowing down charging of each of the lithium-ion batteries, and wherein balancing current should be high enough to effectively balance batteries, but low enough to not interfere with the charge termination scheme used in battery chargers.

The presently described subject matter is directed to a method of battery balancing an electrical series string of lithium-ion batteries, the method comprising: providing multiple lithium-ion batteries connected together in electrical series, the multiple lithium-ion batteries each having a battery management system (BMS) comprising an Analog-to-Digital Converter (ADC), a microcontroller, a MOSFET, and a balancing resistor, using a microcontroller to read the battery voltage using the Analog-to-Digital Converter (ADC) to detect when the battery voltage is near end-of-charge, and then turning on the MOSFET, wherein this sequence shunts a portion of the charge current through the balance resistor, and bypassing the cells of each of the multiple lithium-ion batteries, which has the effect of slowing down charging of each of the lithium-ion batteries, and wherein a value for balancing current to provide adequate balancing and work with most battery chargers is between 100 mA and 500 mA.

The presently described subject matter is directed to a battery balancing system for charging an electrical series string of lithium-ion batteries, the system comprising: multiple lithium-ion batteries connected together in the electrical series string of the lithium-ion batteries, the multiple lithium-ion batteries each having a battery management system (BMS) comprising a comparator, a MOSFET, and a balancing resistor, the comparator configured to detect when the battery voltage of each of lithium-ion batteries is near end-of-charge, and then turning on each respective MOSFET of each of the lithium-ion batteries, wherein this sequence shunts a portion of the charge current flowing through the balance resistor, and bypassing the battery cells of each of the multiple lithium-ion batteries, which has the effect of slowing down charging of each of the lithium-ion batteries, and wherein a single electrical charger is used to charge the multiple lithium-ion batteries connected together in the electrical series string of the lithium-ion batteries.

The presently described subject matter is directed to a battery balancing system for charging an electrical series string of lithium-ion batteries, the system comprising: multiple lithium-ion batteries connected together in electrical series, the multiple lithium-ion batteries each having a battery management system (BMS) comprising an Analog-to-Digital Converter (ADC), a microcontroller, a MOSFET, and a balancing resistor, the microcontroller configured to read the battery voltage using the Analog-to-Digital Converter (ADC) to detect when the battery voltage is near end-of-charge, and then turning on the MOSFET, wherein this sequence shunts a portion of the charge current through the balance resistor, and bypassing the cells of each of the multiple lithium-ion batteries, which has the effect of slowing down charging of each of the lithium-ion batteries, and wherein a single electrical charger is used to charge the multiple lithium-ion batteries connected together in the electrical series string of the lithium-ion batteries.

### BRIEF DESCRIPTION OF THE DRAWINGS

FIG. 1 is a diagrammatic view, for example, of four (4) batteries connected together in an electrical series string. All four (4) batteries are charged and discharged together.

FIG. 2 is a diagrammatic view showing a battery balancing scheme implemented with four (4) battery cells. All components shown are inside the battery. The control method uses a comparator, as shown. Other similar or functionally equivalent control methods can be used.

FIG. 3 is a diagrammatic view showing the balancing scheme implemented in a four (4) cell battery. All components shown are inside the battery. The control method using a micro-controller is shown. Again, other similar or functionally equivalent control methods can be used.

### DETAILED DESCRIPTION

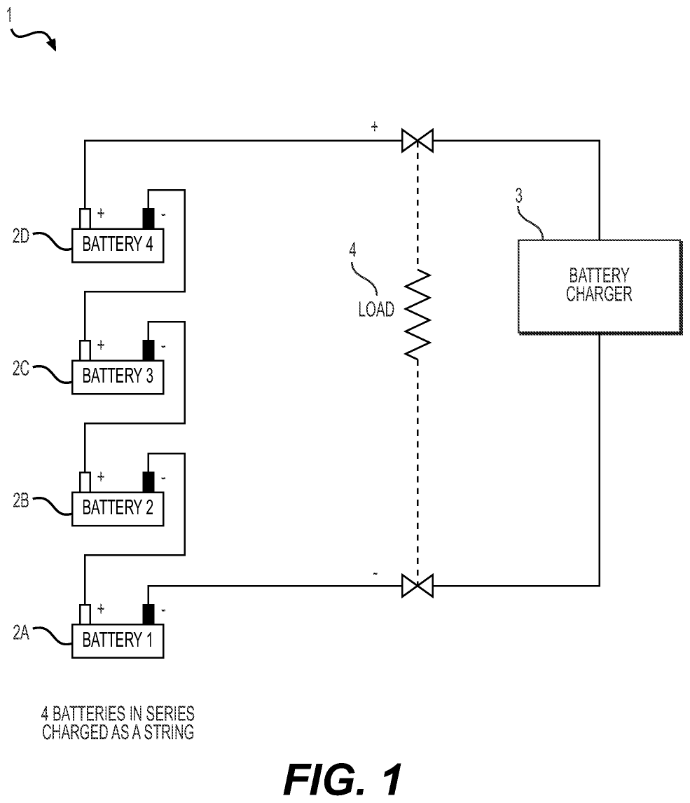

A system or circuit 1 for charging four batteries 2A, 2B, 2C, 2D (Battery 1, Battery 2, Battery 3, Battery 4) connected together in an electrical series string is shown in FIG. 1. The system or circuit 1 comprises the four batteries 2A, 2B, 2C, 2D, a single battery charge 3, and a balance resistor 4 (i.e. load).

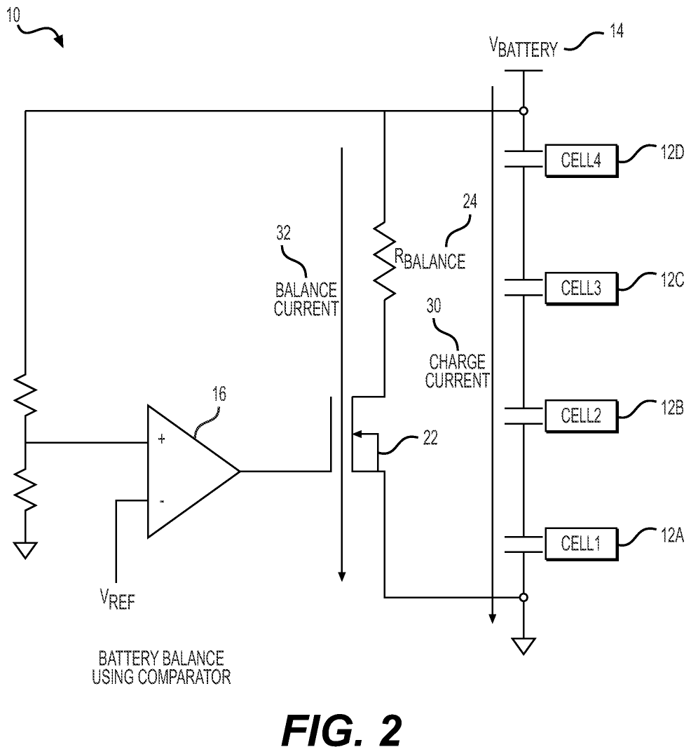

A system or circuit 10 for balancing is shown in FIG. 2. The system or circuit 10 comprises battery cells 12A, 12B, 12C, 12D (Cell #1, Cell #2, Cell #3, Cell #4), a comparator 16, a MOSFET 22, and a balance resistor 24 (i.e. load). The comparator 16 is used to detect when the battery voltage is near end-of-charge, and then turns on the MOSFET 22. This sequence shunts a portion of the charge current 30 (i.e. the balance current 32) through the balance resistor 24, bypassing the battery cells 12A, 12B, 12C, 12D which has the effect of slowing down the charging of that particular battery.

A battery balancing system according to the present invention comprises a plurality of batteries each having the system or circuit 10, and are connected together in an electrical series string. The plurality of batteries are charged using a single charger.

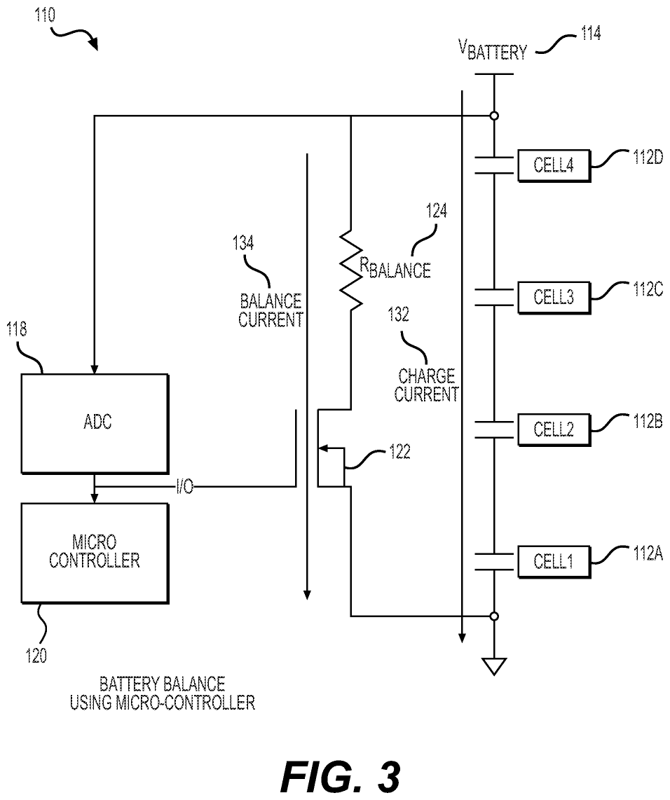

Another system or circuit 110 for balancing according to the present invention is shown in FIG. 3. The system or circuit 110 comprises battery cells 112A, 112B, 112C, 112D (Cell #1, Cell #2, Cell #3, Cell #4), an Analog-to-Digital Converter (ADC) 118, a microcontroller 120, a MOSFET 122, and a balance resistor 124 (i.e. load). The microcontroller 120 reads the battery voltage using the Analog-to-Digital Converter (ADC) 118 to detect when the battery voltage is near end-of-charge, and the turns on the MOSFET 122. This shunts a portion of the charge current 132 (i.e. balance current 132 through the balance resistor 124, bypassing the cells, which has the effect of slowing down the charge.

Another battery balancing system according to the present invention comprises a plurality of batteries each having the system or circuit 110, and are connected together in an electrical series string.

The battery voltage threshold where the balance resistor begins to bypass charge current it set to a voltage that is near the full charge voltage for the particular lithium-ion battery chemistry used. For example, reasonable values for example batteries are given below. Other values can be selected to optimize balancing for a particular battery and chemistry.

### EXAMPLES

1) (3.60V/cell)×(4 cells)=14.4V (4-cell LiFePO₄ with full charge voltage of 3.65V/cell); and
2) (4.18V/cell)×(3 cells)=12.54V (3-cell Cobalt-based battery with full charge voltage of 4.20V/cell)

In the system and method according to the present invention, as the electrical series string of batteries is charged, cell balancing will be turned on in each battery as it reaches the balance threshold described above. Eventually all of the batteries in the electrical series string will have cell balancing turned on.

Balancing is performed only during charging. This requires the balancing system or circuit to detect when the battery is being charged. This is done by setting the voltage threshold for balancing to be near the full charge voltage. When the battery is charging and reaches this threshold, balancing is enabled. After charge termination, the battery voltage will naturally relax to a voltage below the threshold which disables balancing.

Alternately, the control electronics in the Battery Management System (BMS) can provide a signal to the balancing system or circuit that indicates if the battery is being charged.

A consideration in the design is the selection of the balancing current. The balancing current should be high enough to effectively balance batteries, but low enough to not interfere with the charge termination scheme used in battery chargers.

Chargers that utilize Constant Current/Constant Voltage (CC/CV) will terminate charging when the current drops below a certain level during the CV portion of the charge cycle. Typical thresholds used by chargers is 5-10% of the bulk charge current. The balancing current should be below this level to ensure proper charge termination.

Many general purpose battery chargers use only Constant Current (CC) charging. These chargers will reduce the charge current as the battery voltage approaches the termination voltage. The balancing current should be below the lowest charge current level to ensure proper charge termination.

A reasonable value for balancing current to provide adequate balancing and work with most battery chargers is between 100 mA and 500 mA.

The invention described above utilizes passive balancing to achieve balance between electrical series connected batteries. Alternately, active balancing can be used in the same manner.

1. A method of battery balancing an electrical series string of lithium-ion batteries, the method comprising:
providing multiple lithium-ion batteries connected together in the electrical series string of the lithium-ion batteries, the multiple lithium-ion batteries each having a battery management system (BMS) comprising a comparator, a MOSFET, and a balancing resistor,
using the comparator to detect when the battery voltage of each of lithium-ion batteries is near end-of-charge, and then turning on each respective MOSFET of each of the lithium-ion batteries,
wherein this sequence shunts a portion of the charge current flowing through the balance resistor, and bypassing the battery cells of each of the multiple lithium-ion batteries, which has the effect of slowing down charging of each of the lithium-ion batteries, and
wherein a single electrical charger is used to charge the multiple lithium-ion batteries connected together in the electrical series string of the lithium-ion batteries.

2. A method of battery balancing an electrical series string of lithium-ion batteries, the method comprising:
providing multiple lithium-ion batteries connected together in electrical series, the multiple lithium-ion batteries each having a battery management system (BMS) comprising an Analog-to-Digital Converter (ADC), a microcontroller, a MOSFET, and a balancing resistor,
using a microcontroller to read the battery voltage using the Analog-to-Digital Converter (ADC) to detect when the battery voltage is near end-of-charge, and then turning on the MOSFET,
wherein this sequence shunts a portion of the charge current through the balance resistor, and bypassing the cells of each of the multiple lithium-ion batteries, which has the effect of slowing down charging of each of the lithium-ion batteries, and
wherein a single electrical charger is used to charge the multiple lithium-ion batteries connected together in the electrical series string of the lithium-ion batteries.

3. The method of claim 1, wherein a battery voltage threshold where the balance resistor begins to bypass charge current it set to a voltage that is near the full charge voltage for the particular lithium-ion battery chemistry used.

4. The method according to claim 3, wherein as the electrical series string of batteries is charged, cell balancing will be turned on in each battery as it reaches the balance threshold, and eventually all of the batteries in the electrical series string will have cell balancing turned on.

5. The method according to claim 1, wherein balancing is performed only during charging.

6. The method according to claim 5, wherein the balancing requires the balancing circuit to detect when the battery is being charged.

7. The method according to claim 6, wherein the balancing is done by setting the voltage threshold for balancing to be near the full charge voltage, and when the battery is charging and reaches this threshold, balancing is enabled.

8. The method according to claim 7, wherein after charge termination, the battery voltage will naturally relax to a voltage below the threshold which disables balancing.

9. The method according to claim 1, wherein control electronics in the battery management system (BMS) can provide a signal to the balancing circuit that indicates if the battery is being charged.

10. The method according to claim 1, wherein balancing current should be high enough to effectively balance batteries, but low enough to not interfere with the charge termination scheme used in battery chargers.

11. The method according to claim 1, wherein a value for balancing current to provide adequate balancing and work with most battery chargers is between 100 mA and 500 mA.

12. The method of claim 2, wherein a battery voltage threshold where the balance resistor begins to bypass charge current it set to a voltage that is near the full charge voltage for the particular lithium-ion battery chemistry used.

13. The method according to claim 12, wherein as the electrical series string of batteries is charged, cell balancing will be turned on in each battery as it reaches the balance threshold, and eventually all of the batteries in the electrical series string will have cell balancing turned on.

14. The method according to claim 2, wherein balancing is performed only during charging.

15. The method according to claim 14, wherein the balancing requires the balancing circuit to detect when the battery is being charged.

16. The method according to claim 15, wherein the balancing is done by setting the voltage threshold for balancing to be near the full charge voltage, and when the battery is charging and reaches this threshold, balancing is enabled.

17. The method according to claim 16, wherein after charge termination, the battery voltage will naturally relax to a voltage below the threshold which disables balancing.

18. The method according to claim 2, wherein control electronics in the battery management system (BMS) can provide a signal to the balancing circuit that indicates if the battery is being charged.

19. The method according to claim 2, wherein balancing current should be high enough to effectively balance batteries, but low enough to not interfere with the charge termination scheme used in battery chargers.

20. The method according to claim 2, wherein a value for balancing current to provide adequate balancing and work with most battery chargers is between 100 mA and 500 mA.

21. A battery balancing system for charging an electrical series string of lithium-ion batteries, the system comprising:
multiple lithium-ion batteries connected together in the electrical series string of the lithium-ion batteries, the multiple lithium-ion batteries each having a battery management system (BMS) comprising a comparator, a MOSFET, and a balancing resistor, the comparator configured to detect when the battery voltage of each of lithium-ion batteries is near end-of-charge, and then turning on each respective MOSFET of each of the lithium-ion batteries,
wherein this sequence shunts a portion of the charge current flowing through the balance resistor, and bypassing the battery cells of each of the multiple lithium-ion batteries, which has the effect of slowing down charging of each of the lithium-ion batteries, and
wherein a single electrical charger is used to charge the multiple lithium-ion batteries connected together in the electrical series string of the lithium-ion batteries.

22. A battery balancing system for charging an electrical series string of lithium-ion batteries, the system comprising:
multiple lithium-ion batteries connected together in electrical series, the multiple lithium-ion batteries each having a battery management system (BMS) comprising an Analog-to-Digital Converter (ADC), a microcontroller, a MOSFET, and a balancing resistor, the microcontroller configured to read the battery voltage using the Analog-to-Digital Converter (ADC) to detect when the battery voltage is near end-of-charge, and then turning on the MOSFET,
wherein this sequence shunts a portion of the charge current through the balance resistor, and bypassing the cells of each of the multiple lithium-ion batteries, which has the effect of slowing down charging of each of the lithium-ion batteries, and
wherein a single electrical charger is used to charge the multiple lithium-ion batteries connected together in the electrical series string of the lithium-ion batteries.
